(19) United States
(12) Patent Application Publication
(10) Pub. No.: US 2006/0091981 A1
(43) Pub. Date: May 4, 2006

(54) Method and system for frequency trimming

(75) Inventors: Joe M. Smith, Scottsdale, AZ (US); John C. Estes, Tempe, AZ (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/980,998

(22) Filed: Nov. 4, 2004

(51) Int. Cl. H01P 7/00

(52) U.S. Cl. 333/235

(57) ABSTRACT

A method (200) of frequency trimming an electronic device (100) such as a resonator or filter can include the steps of providing (202) an external trimmable portion (10) of a multi-port trim network and selectively removing (204) at least a portion of the external trimmable portion to selectively increase or decrease the frequency of the electronic device. Selectively removing can include selectively removing (206) the portion of the external trimmable portion to selectively increase the frequency by reducing a parallel capacitance of the external trimmable portion or alternatively selectively removing (208) the portion of the external trimmable portion to selectively decrease the frequency by increasing a series inductance of the external trimmable portion. Trimming of the frequency up or down can be done without affecting (210) any main resonating structures of the electronic device and without adding (212) metal to the external trimmable portion.

### FIELD OF THE INVENTION

This invention relates generally to trimming techniques and networks, and more particularly to a method and system for frequency trimming for voltage controlled oscillator (VCO) and filtering applications.

### BACKGROUND OF THE INVENTION

Due to surface mount part variations and variations in substrate properties it is often necessary to fine trim the frequency of a low temperature co-fired ceramic (LTCC) based VCO or filter to achieve a desired performance. The fine trimming occurs after module assembly and is typically done using an automated laser trimming device to remove part of a metallization pattern while monitoring frequency. In most trimming techniques, metal is trimmed away to move frequency in one direction and metal is added back to move the frequency in the opposite direction. Having to remove and add metal to adjust frequency is typically difficult to implement and usually unreliable. No existing technique known trims away a trimming network to selectively increase or decrease an operating frequency.

U.S. Pat. No. 6,181,225 to Allen W. Bettner discusses a laser tunable thick film microwave resonator that has a single port resonator structure made up of a grounded microstrip line that is adjusted either higher or lower in frequency by removing part of the ground plane below the resonator. The Bettner patent does not apply to a two or multi-port network and fails to have a trimming system that is independent of the ground plane or resonator which would allow for a more general application to other circuits. Also, since trimming of the network in Bettner is done by removing portions of the ground plane, its application is limited to cases where the ground plane is on one of the outer layers so that it will be accessible for trimming. At least one ground plane for the resonator must be on an external layer so that it can be accessed for trimming. Therefore, the teachings in Bettner would be inapplicable for devices having embedded ground planes.

### SUMMARY OF THE INVENTION

Embodiments in accordance with the present invention can provide a trim network useful for trimming the frequency of a VCO, filter or other frequency sensitive RF or microwave circuit. The network allows trimming either up or down in frequency.

In a first embodiment of the present invention, a method of frequency trimming an electronic device such as a resonator or filtering device can include the steps of providing an external trimmable portion of a multi-port trim network such as a two-port trim network and selectively removing at least a portion of the external trimmable portion to selectively increase or decrease the frequency of the electronic device. The external trimmable portion can be a single integrated structure apart or independent from the resonator, ground plane or other main structures of the electronic device. The step of selectively removing can include the step of selectively removing the portion of the external trimmable portion to selectively increase the frequency by reducing a parallel capacitance of the external trimmable portion or alternatively the step of selectively removing the portion of the external trimmable portion to selectively decrease the frequency by increasing a series inductance of the external trimmable portion. The trimming of the frequency up or down can be done without affecting any main resonating structures of the electronic device and without adding metal to the external trimmable portion.

In a second embodiment of the present invention, a multi-port trim network can include a unitary external trim element having at least a first port and a second port and at least one notch formed on the unitary external trim element to selectively either increase or decrease the frequency of a device used in conjunction with the multi-port trim network. Note, the frequency can be selectively increased by removing a portion of the unitary external trim element to reduce a parallel capacitance of the unitary external trim element. For example, a portion of the unitary external trim element can be notched in a horizontal fashion to increase the frequency of the device. Likewise, the frequency can be selectively decreased by removing a portion of the unitary external trim element to increase a series inductance of the unitary external trim element. For example, a portion of the unitary external trim elements can be notched in a vertical fashion to decrease the frequency of the device. The multi-port trim network can be independent of a resonator or other component forming a portion of the device and can be used with any number of devices such as an inductor, a capacitor, a shorted stub resonator, an open stub resonator, a voltage controlled oscillator, and a resonator for example.

In a third embodiment of the present invention, a circuit on a module can include a substrate, a ground plane at least on or within the substrate, at least one resonator coupled to the ground plane, and a multi-port trim network having an external trim area on the substrate. Note, trimming of the external trim area causes the circuit to either increase or decrease the frequency of the circuit. If the module includes a resonator, the trimming of the external trim area does not affect the resonator or resonator ground plane. The multi-port trim network can be used with a variety of external components which can include an inductor, a capacitor, a shorted stub resonator, an open stub resonator, a voltage controlled oscillator, or a resonator as examples. The frequency of the multi-port trim network can be selectively increased by removing a portion of the external trim area to reduce a parallel capacitance of the multi-port trim network or decreased by removing a portion of the external trim area to increase a series inductance of the multi-port trim network. For example, the portion of the external trim area is notched in a horizontal fashion to increase the frequency of the circuit or notched in a vertical fashion to decrease the frequency of the circuit.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a schematic diagram of a trim network equivalent circuit in accordance with an embodiment of the present invention.

FIG. 2 is a schematic diagram of a trim network application in a VCO in accordance with an embodiment of the present invention.

FIG. 3 is a 3 dimensional representation of a trim network in accordance with an embodiment of the present invention.

FIG. 4 is a top view of the trim network of FIG. 3 before trimming in accordance with an embodiment of the present invention.

FIG. 5 is a top view of the trim network of FIG. 3 with an inductive trim using a vertical notch in accordance with an embodiment of the present invention.

FIG. 6 is a top view of the trim network of FIG. 3 with an capacitive trim using a horizontal notch in accordance with an embodiment of the present invention

FIG. 7 is a 3 dimensional representation of a typical circuit application using an embedded inductor and a trim network in accordance with an embodiment of the present invention.

FIG. 8 is a chart illustrating an inductive trim in nano-Henries v. trim notch length in millimeters in accordance with an embodiment of the present invention.

FIG. 9 is a chart illustrating a capacitive trim in picoFarads v. trim notch height in accordance with an embodiment of the present invention.

FIG. 10 is a flow chart illustrating a method of frequency trimming an electronic device in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments in accordance with the present invention generally avoids the need to trim the ground plane. Furthermore, multi-port trim networks as disclosed herein do not necessarily require a resonator and therefore can be applied in a more general fashion to other electronic devices such as inductors, capacitors, shorted or open stub resonators or any other components used to determine the operating frequency of the circuit in which it is used.

One embodiment of the present invention includes a network which is formed by printed or deposited conductive patterns separated by a substrate material. The trimable part of the network can be external and can be either on a top or bottom layer or possibly on a side of a module. Part of a conductive material of the network can be removed, using a laser or some other method, causing the network to either reduce the parallel capacitance or increase the series inductance to adjust a frequency up or down. Reducing the capacitance will raise the frequency of the circuit while increasing the series inductance will lower the frequency. Whether the capacitance is reduced or the inductance is increased is dependent on how the material on the top layer is removed.

As discussed above, the techniques for trimming to either increase or decrease frequency can be applied in a more general way than existing techniques or devices. Existing systems that are trimable both up or down in frequency do it by trimming a ground under a resonator. These systems or techniques limit the versatility in many applications (such as multilayer LTCC or PCB) where the resonator may be embedded within many layers between two ground planes that may not be accessible for laser trimming. Using the embodiments disclosed herein, a resonator and a ground plane or ground planes can be placed on any layer since the trim network is not physically part of the resonator.

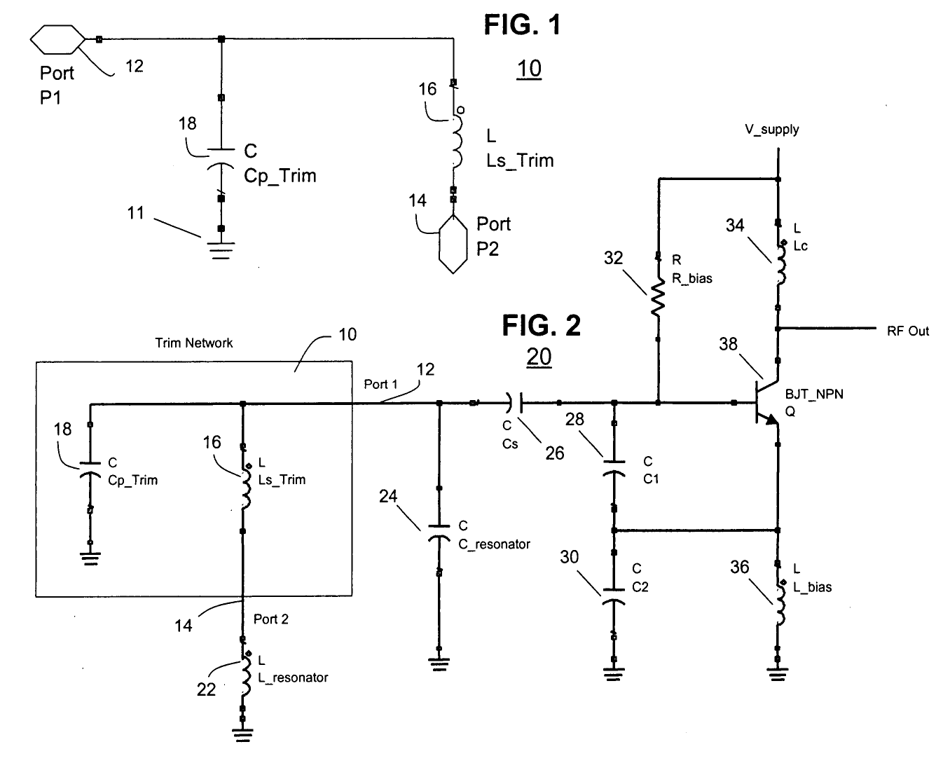

In one embodiment, an equivalent circuit of a two port trim network 10 as shown in the schematic of FIG. 1, can be used for a fine trim in a receiver VCO 20 as shown in FIG. 2. The trim network can include a first port 12 and a second port 14 with a portion 18 of the trim network 10 that can be capacitively trimmed and another portion 16 of the trim network 10 that can be inductively trimmed. The receiver VCO 20 can include a resonator having an inductive portion 22 coupled to ground via the second port 14 of the trim network 10 and a capacitive portion 24 coupled to ground via the first port 12 of the trim network 10. The receiver VCO 20 can further include a plurality of capacitors 26, 28, 30, inductors 34, 36, and at least one resistor 32 coupled to a transistor 38 to form the oscillator and amplifier portions of the receiver VCO 20 as is known in the art. The trim network 10 can be embedded on one or more layers of a multi-layer LTCC substrate for example. Other substrate layers can be used for embedding most of the critical passive components of the VCO. The design of a network in accordance with embodiments herein can allow the VCO to be trimmed either up or down in frequency. Although the trim network herein was initially conceived for use as a VCO trim, it is also possible and contemplated that the trim network can be used in other applications such as embedded filters that require frequency trimming. While the material contemplated for this design can use ceramic, the application can easily be adapted to more common substrate materials such as G10 or Polyimide.

As illustrated in FIG. 2, the second port 14 is connected to a resonator, an inductor or a capacitor that is part of the frequency selective network in the VCO or filter. The first port 12 connects to the VCO at the node that the resonator, capacitor or inductor would normally connect if no trim network was used. By making trim adjustments, the values of Ls_Trim (16) and Cp_Trim (18), shown in FIGS. 1 and 2, are changed. When trimming, either the series inductance, Ls_Trim, is increased or the parallel capacitance, Cp_trim, is decreased. Increasing Ls_Trim has the effect of lowering the frequency while decreasing Cp_Trim increases the frequency. The ability of the trim network 10 to either increase or decrease frequency allows the nominal frequency of the VCO to be the same as the desired final frequency. A trim network that moves the frequency in only one direction requires the design frequency to be offset by the worst case expected frequency error for all units. In addition, if over trimming occurs with this network (by vertical notching for example), it is possible to compensate by trimming in the opposite direction (by horizontal notching) to correct the error and further preventing the unit from being rejected due to over trimming.

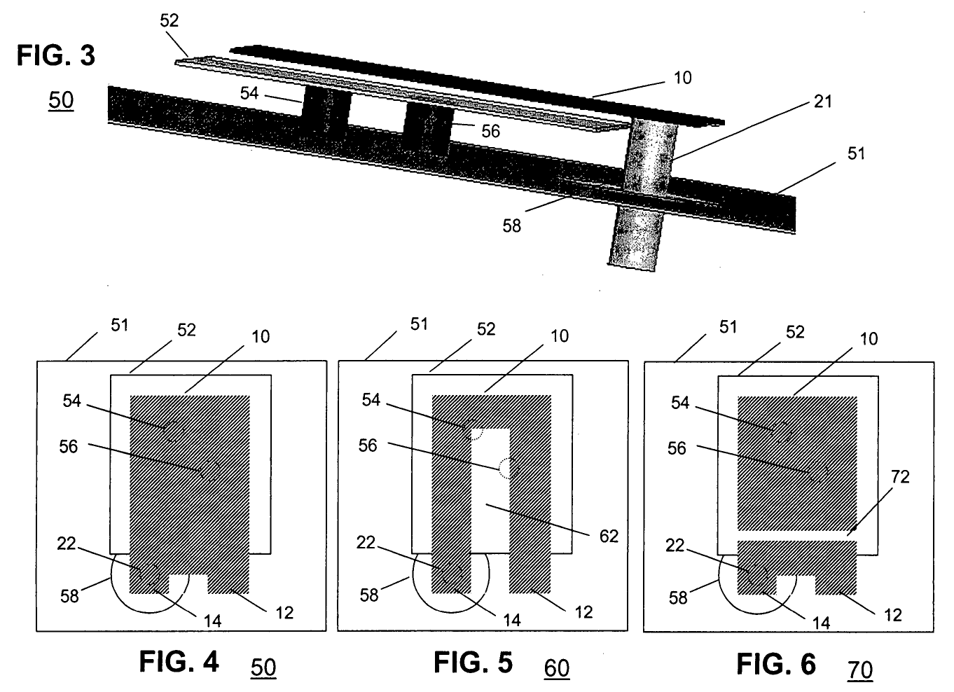

A 3-d view of a physical layout 50 of the trim network 10 is shown in FIG. 3. The same network is also shown in FIGS. 4 through 6 at various stages of trimming. In the figures, a top metal layer forms a trimable metal pad of the trim network 10. In one embodiment, the size of the trim pad on the top layer can be approximately 1 mm×0.6 mm. A second layer 52 can have a larger conductive pad that can be approximately 40 um below the trim pad on the top layer. The second layer 52 can be connected to a ground layer 51 with several vias 54 and 56. The ground layer can be approximately 160 um below the top layer metal. A via 21 can connect the top layer (10) to another ground layer (not shown) via a resonator (not shown) that goes through an aperture 58 in the ground layer 51.

Referring to FIG. 4, the layout 50 with the trim network 10 is shown before trimming. It also shows the location of the input and output ports, namely the first port 12 and the second port 14, which are indicated on the schematics in FIGS. 1 and 2. Referring to the layout 60 of FIG. 5, the trim network 10 is shown after completing an inductive trim for maximum series inductance, by cutting a vertical notch 62. Referring to the layout 70 of FIG. 6, the trim network 10 is shown after completing a capacitive trim for minimum parallel capacitance, by cutting a horizontal notch 72.

In practice, to make an inductive trim, the notch 62 can be continuously increased from the minimum value (shown in FIG. 4) until the desired frequency is reached. For the capacitive trim, the horizontal notch 72 can be cut somewhere between what is shown in FIG. 6 and the top of the trim pad (10), until the desired frequency is reached. A final capacitive trim may require several horizontal cuts (starting at the top and working down) before reaching the final frequency.

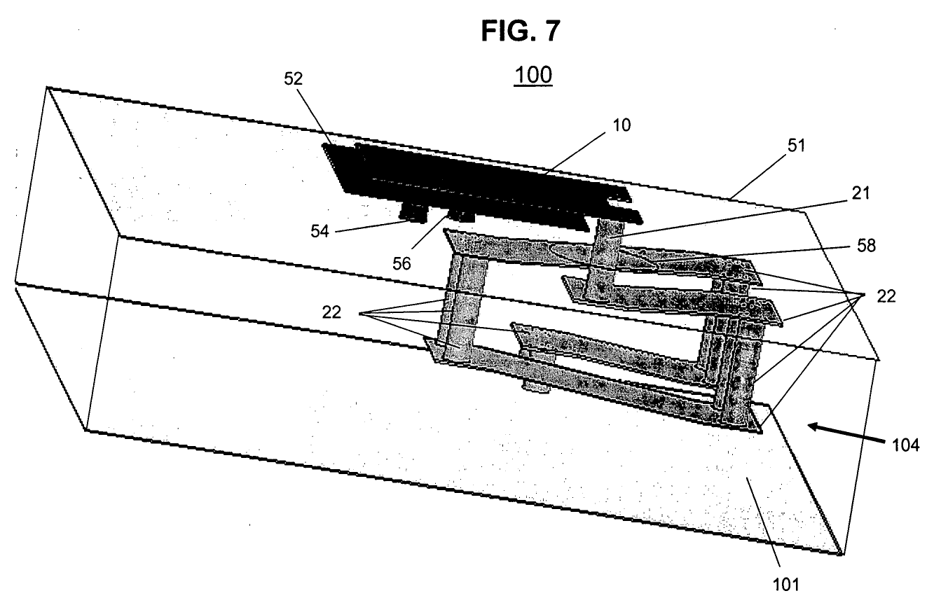

Referring to FIG. 7, a trim network 10 used in a typical application where an inductor or resonator network 22 is connected from the second port 14 (shown in FIGS. 1-6) to ground 101 using via 21. The via 21 and the inductor or resonator network 22 can be embedded between two ground planes (51 and 101) within a substrate 104 while the trim network 10 is on top of the ground plane 51. The embodiment shown in FIG. 7 illustrates the flexibility and versatility over other arrangements in that the trim network 10 can be separate from the resonator or resonator network 22 allowing the ground planes for the resonator to be embedded on internal layers if desired. As mentioned in the background, existing systems require at least one ground plane for the resonator to be on an external layer to provide access for trimming whereas embodiments in accordance with the present embodiment do not have such a requirement.

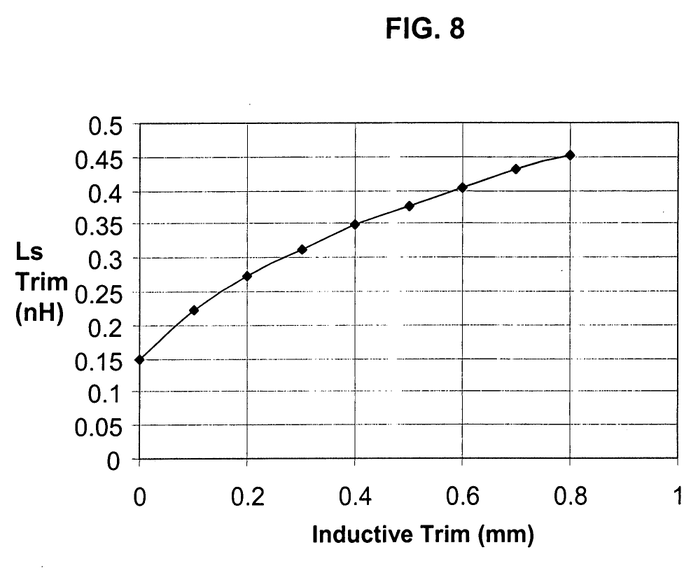

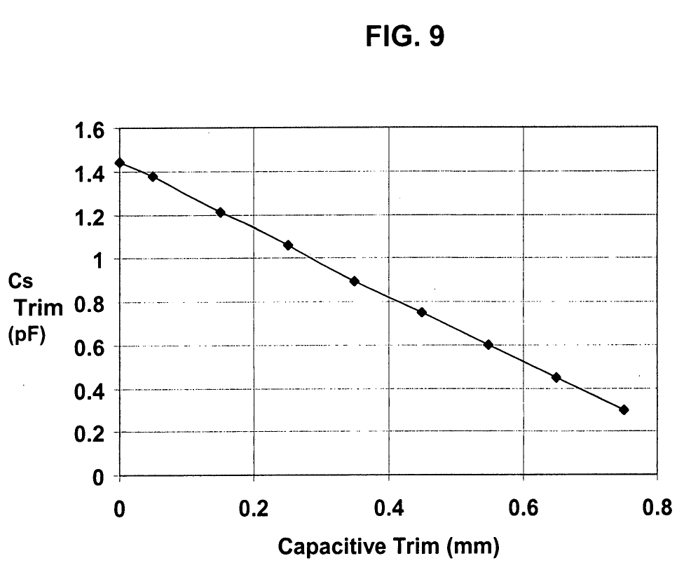

Referring once again to the vertical and horizontal notches of FIGS. 5 and 6, a designer of an electronic device such as a VCO can utilize charts to more accurately trim a trim network to reduce the number of cuts required to achieve a desired frequency. The chart of FIG. 8 shows the value of Ls_Trim (in nano Henrys) versus the trim notch length (in millimeters). Notch 62 in FIG. 5 can be trimmed to the length indicated to obtain the desired frequency. The chart of FIG. 9 shows the value of Cp_Trim (in pico-Farads) versus the height (in millimeters) of the horizontal notch relative to the top of the pad. Notch 72 in FIG. 6 can also be trimmed to the appropriate height to obtain a desired frequency. To reduce the number of cuts required for a capacitive or inductive trim and to reduce the number of frequency measurements required, the curves in FIGS. 8 and 9 can be used to predict the inductive trim length or the capacitive trim height based on an initial measured frequency error. The use of a different substrate or layout would typically require a new set of trim curves relating trim length to capacitance or inductance change. The capacitance or inductance change can then be related to a frequency change which is dependent on the particular VCO design.

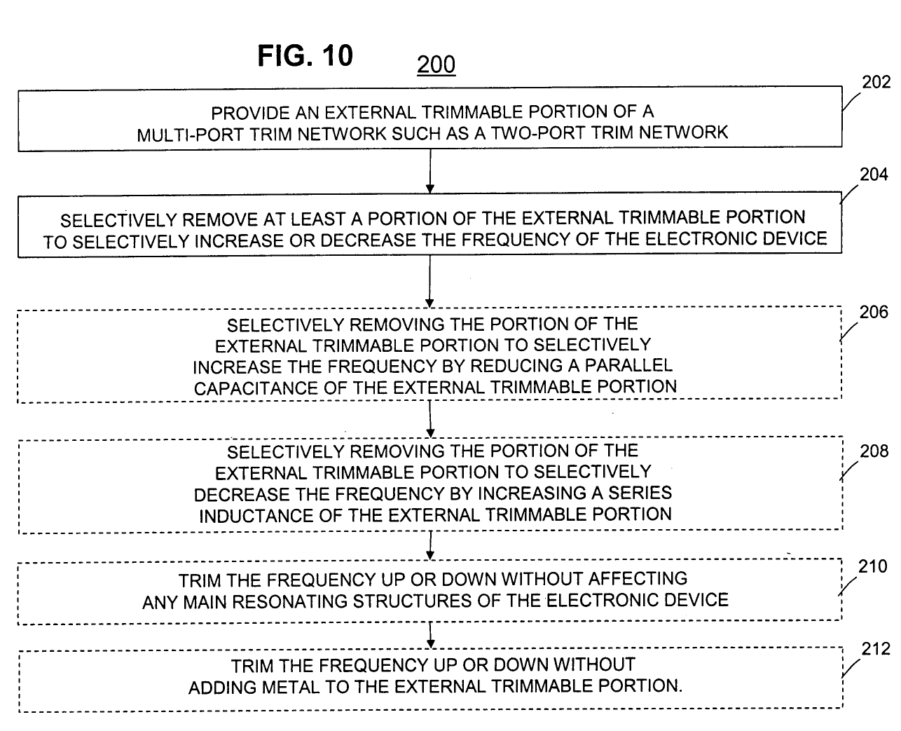

Referring to FIG. 10, a flow chart illustrating a method 200 of frequency trimming an electronic device such as a resonator or filtering device can include the steps 202 of providing an external trimmable portion of a multi-port trim network such as a two-port trim network and the step 204 of selectively removing at least a portion of the external trimmable portion to selectively increase or decrease the frequency of the resonator device. Note, the external trimmable portion can be a single integrated structure apart or independent from the resonator, ground plane or other main structures of the electronic device. The step of selectively removing can include the step 206 of selectively removing the portion of the external trimmable portion to selectively increase the frequency by reducing a parallel capacitance of the external trimmable portion or alternatively the step 208 of selectively removing the portion of the external trimmable portion to selectively decrease the frequency by increasing a series inductance of the external trimmable portion. The trimming of the frequency up or down can be done without affecting any main resonating structures of the electronic device as shown at step 210. Furthermore, the trimming of frequency up or down can also be done at step 212 without adding metal to the external trimmable portion.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of frequency trimming an electronic device, comprising the steps of:
providing an external trimmable portion of a multi-port trim network, wherein the external trimmable portion is a single integrated structure; and
selectively removing at least a portion of the external trimmable portion to selectively increase or decrease the frequency of the electronic device.

2. The method of claim 1, wherein the step of selectively removing to selectively increase the frequency comprises the step of removing the portion of the external trimmable portion to reduce a parallel capacitance of the external trimmable portion.

3. The method of claim 1, wherein the step of selectively removing to selectively decrease the frequency comprises the step of removing the portion of the external trimmable portion to increase a series inductance of the external trimmable portion.

4. The method of claim 1, wherein the method further comprises the step of trimming the frequency up or down without affecting any main resonating structures of the resonating device.

5. The method of claim 4, wherein the frequency is adjusted up or down without adding additional metal to the external trimmable portion.

6. A multi-port trim network, comprising:
a unitary external trim element having at least a first port and a second port; and
at least one notch formed on the unitary external trim element to selectively either increase or decrease the frequency of a device used in conjunction with the multi-port trim network.

7. The multi-port trim network of claim 6, wherein the frequency is selectively increased by removing a portion of the unitary external trim element to reduce a parallel capacitance of the unitary external trim element.

8. The multi-port trim network of claim 7, wherein the portion of the unitary external trim element is notched in a horizontal fashion to increase the frequency of the device.

9. The multi-port trim network of claim 6, wherein the frequency is selectively decreased by removing a portion of the unitary external trim element to increase a series inductance of the unitary external trim element.

10. The multi-port trim network of claim 9, wherein the portion of the unitary external trim elements is notched in a vertical fashion to decrease the frequency of the device.

11. The multi-port trim network of claim 6, wherein the two port trim network trims the frequency up or down without affecting any main resonating structures of a resonating device forming a portion of the device.

12. The multi-port trim network of claim 11, wherein the frequency is adjusted up or down without adding additional metal to the unitary external trim element.

13. The multi-port trim network of claim 6, wherein the multi-port trim network is independent of a resonator forming a portion of the device.

14. The multi-port trim network of claim 6, wherein the multi-port trim network is used with at least one among an inductor, a capacitor, a shorted stub resonator, an open stub resonator, a voltage controlled oscillator, and a resonator.

15. A circuit on a module, comprising:
a substrate;
a ground plane at least on or within the substrate;
at least one resonator coupled to the ground plane; and
a multi-port trim network having an external trim area on the substrate, wherein a trimming of the external trim area causes the circuit to either increase or decrease the frequency of the circuit.

16. The circuit of claim 15, wherein the trimming of the external trim area fails to affect the resonator and ground plane forming the module.

17. The circuit of claim 15, wherein the two port trim network is used with at least one among an inductor, a capacitor, a shorted stub resonator, an open stub resonator, a voltage controlled oscillator, and the at least one resonator.

18. The circuit of claim 15 wherein the frequency of the multi-port trim network is selectively increased by removing a portion of the external trim area to reduce a parallel capacitance of the multi-port trim network or decreased by removing a portion of the external trim area to increase a series inductance of the two port trim network.

19. The two port trim network of claim 18, wherein the portion of the external trim area is notched in a horizontal fashion to increase the frequency of the circuit or notched in a vertical fashion to decrease the frequency of the circuit.
